(19) United States
(12) Patent Application Publication
(10) Pub. No.: US 2026/0330416 A1
(43) Pub. Date: Oct. 22, 2026

(54) SYSTEMS, APPARATUSES, METHODS, AND COMPUTER PROGRAM PRODUCTS FOR PROJECT PROGRAM GENERATION

(71) Applicant: HONEYWELL INTERNATIONAL INC., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/650,862

(22) Filed: Apr. 17, 2026

Related U.S. Application Data
(60) Provisional application No. 63/790,889, filed on Apr. 18, 2025.

(51) Int. Cl. G06Q 10/10; G06Q 10/0631

(52) U.S. Cl. CPC G06Q 10/103; G06Q 10/06313

(57) ABSTRACT

Systems, apparatuses, methods, and computer program products are provided herein. For example, a method provided herein may include determining a resource for a project based on a user input or a project proposal electronic record; obtaining respective program data from a plurality of data sources based on the resource, the respective program data being associated with one of a plurality of resource providers; generating an impact value for the resource providers based on the respective program data; generating, based on the impact values of the resource providers, a predictive output comprising: a ranking of the resource providers; and an indication of a program for obtaining the resource, the program being based on a top-ranked resource provider and comprising an associated impact value; generating a resource cost electronic record based on the predictive output; and causing performance of a project responsive action based on the resource cost electronic record.

### CROSS REFERENCE TO RELATED APPLICATIONS

This application claims the benefit of and priority to U.S. Application No. 63/790,889, filed Apr. 18, 2025, entitled “SYSTEMS, APPARATUSES, METHODS, AND COMPUTER PROGRAM PRODUCTS FOR PROJECT PROGRAM GENERATION,” the disclosure of which is incorporated herein by reference in its entirety.

### TECHNOLOGICAL FIELD

Embodiments of the present disclosure relate generally to systems, apparatuses, methods, and computer program products for project program generation.

### BACKGROUND

Applicant has identified many technical challenges and difficulties associated with systems, apparatuses, methods, and computer program products for project program generation. Through applied effort, ingenuity, and innovation, Applicant has solved problems related to systems, apparatuses, methods, and computer program products for project program generation by developing solutions embodied in the present disclosure, which are described in detail below.

### BRIEF SUMMARY

Various embodiments described herein relate to systems, apparatuses, methods, and computer program products for project program generation.

In accordance with one aspect of the disclosure a method is provided. In some embodiments, the method comprises determining at least one resource for a project based at least in part on at least one of a user input or a project proposal electronic record. In some embodiments, the method comprises obtaining respective program data from a plurality of data sources based at least in part on the at least one resource, wherein the respective program data is associated with one of a plurality of resource providers for the at least one resource. In some embodiments, the method comprises generating at least one impact value for the plurality of resource providers based at least in part on the respective program data. In some embodiments, the method comprises generating, based at least in part on the at least one impact value of the plurality of resource providers, a predictive output comprising: a ranking of the plurality of resource providers; and an indication of a program for obtaining the at least one resource, wherein the program is based at least in part on a top-ranked entry of the ranking and comprises the at least one impact value associated with the top-ranked entry of the ranking. In some embodiments, the method comprises generating a resource cost electronic record based at least in part on the predictive output and the at least one impact value associated with the top-ranked entry of the ranking. In some embodiments, the method comprises causing performance of at least one project responsive action based at least in part on the resource cost electronic record.

In some embodiments, the at least one impact value comprises at least one availability metric associated with the at least one resource. In some embodiments, the at least one impact value comprises at least one resource cost associated with the at least one resource. In some embodiments, the at least one impact value comprises a stability metric associated with the resource provider. In some embodiments, the at least one impact value comprises a quality metric associated with the resource provider. In some embodiments, the at least one impact value comprises at least one duty metric associated with at least one of the resource or the resource provider. In some embodiments, the at least one impact value comprises at least one transportation metric associated with at least one of the resource or the resource provider.

In some embodiments, the performance of the at least one project responsive action comprises provisioning the resource cost electronic record to at least one computing device. In some embodiments, the method further comprises, in response to receiving from the at least one computing device, an approval of the program for obtaining the at least one resource, provisioning to a second computing device a request configured in accordance with the program for obtaining the at least one resource, wherein: the second computing device is associated with the top-ranked entry of the ranking.

In some embodiments, the method further comprises detecting at least one change to the respective program data for at least one of the plurality of resource providers. In some embodiments, the method further comprises updating the at least one impact value for the at least one of the plurality of resource providers based at least in part on the at least one change to the respective program data. In some embodiments, the method further comprises generating, based at least in part on the at least one updated impact value, a second predictive output comprising a second ranking of the plurality of resource providers and an indication of a second program for obtaining the at least one resource. In some embodiments, the method further comprises modifying the resource cost electronic record based at least in part on the second predictive output and the at least one impact value associated with the top-ranked entry of the second ranking. In some embodiments, the method further comprises adjusting, based at least in part on the modified resource cost electronic record, the performance of the at least one project responsive action. In some embodiments, the method further comprises causing performance of a second project responsive action based at least in part on the modified resource cost electronic record.

In some embodiments, the plurality of data sources comprises a plurality of external project application devices. In some embodiments, the plurality of data sources comprises a plurality of external project implementation devices.

In some embodiments, the method further comprises determining at least one project requirement based at least in part on at least one of the following: at least one project documentation electronic record; or at least one project requirement electronic record. In some embodiments, the method further comprises determining the at least one resource for the project based at least in part on the at least one project requirement.

In some embodiments, the method further comprises causing rendering of a graphical user interface (GUI) on a display of at least one computing device, the GUI being representative of the resource cost electronic record.

In some embodiments, the method further comprises generating the predictive output using at least one machine learning model. In some embodiments, the at least one machine learning model comprises at least one large language model (LLM).

In some embodiments, the program for obtaining the at least one resource is configured to optimize a cost of the at least one resource and a predicted interval for receiving the at least one resource.

In accordance with one aspect of the disclosure an apparatus is provided. In some embodiments, the apparatus comprises memory and one or more processors communicatively coupled to the memory. In some embodiments, based at least in part on at least one of a user input or a project proposal electronic record, the one or more processors are configured to determine at least one resource for a project. In some embodiments, the one or more processors are configured to obtain respective program data from a plurality of data sources based at least in part on the at least one resource. In some embodiments, the respective program data is associated with one of a plurality of resource providers for the at least one resource. In some embodiments, the one or more processors are configured to generate at least one impact value for the plurality of resource providers based at least in part on the respective program data. In some embodiments, the one or more processors are configured to generate, based at least in part on the at least one impact value of the plurality of resource providers, a predictive output. In some embodiments, the predictive output comprises a ranking of the plurality of resource providers and an indication of a program for obtaining the at least one resource, wherein the program is based at least in part on a top-ranked entry of the ranking and comprises the at least one impact value associated with the top-ranked entry of the ranking. In some embodiments, the one or more processors are configured to generate a resource cost electronic record based at least in part on the predictive output and the at least one impact value associated with the top-ranked entry of the ranking. In some embodiments, the one or more processors are configured to cause performance of at least one project responsive action based at least in part on the resource cost electronic record.

In accordance with one aspect of the disclosure a computer program product is provided. In some embodiments, the computer program product comprises at least one non-transitory computer-readable storage medium having computer program code stored thereon. In some embodiments, based at least in part on at least one of a user input or a project proposal electronic record, the computer program code, in execution with at least one processor, configures the computer program product for determining at least one resource for a project. In some embodiments, the one or more processors are configured to obtain respective program data from a plurality of data sources based at least in part on the at least one resource. In some embodiments, the respective program data is associated with one of a plurality of resource providers for the at least one resource. In some embodiments, the computer program code, in execution with at least one processor, configures the computer program product for generating at least one impact value for the plurality of resource providers based at least in part on the respective program data. In some embodiments, the computer program code, in execution with at least one processor, configures the computer program product for generating, based at least in part on the at least one impact value of the plurality of resource providers, a predictive output. In some embodiments, the predictive output comprises a ranking of the plurality of resource providers and an indication of a program for obtaining the at least one resource, wherein the program is based at least in part on a top-ranked entry of the ranking and comprises the at least one impact value associated with the top-ranked entry of the ranking. In some embodiments, the computer program code, in execution with at least one processor, configures the computer program product for generating a resource cost electronic record based at least in part on the predictive output and the at least one impact value associated with the top-ranked entry of the ranking. In some embodiments, the computer program code, in execution with at least one processor, configures the computer program product for causing performance of at least one project responsive action based at least in part on the resource cost electronic record.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure; and

FIG. 4 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

As used herein, the terms “data,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal.

As used herein, the term “computing device” refers to computer hardware and/or software that is configured to access functionality of and/or communicate with the resource allocation system. Computing devices may include, without limitation, smart phones, tablet computers, laptop computers, wearables, personal computers, enterprise computers, and the like.

As used herein, “application” refers to any program code executable by logic circuitry of one or more computing devices, such as a server processor. In some embodiments, an application is a computer program accessible to an entity via a computing device and which performs a specific function directly or indirectly for the entity, the computing device, another application, and/or the like. In some embodiments, an application includes a local software program installed and executed on a computing device accessible to an entity. In some embodiments, an application includes a remotely executed software program accessible to the entity via a computing device of the entity and a suitable network connection to the corresponding remote computing environment.

As used herein, the term “project” refers to any number of programs, initiatives, and/or the like, that include computer-performed tasks, computer-aided tasks, user-performed tasks, and/or the like. A task may be a specific unit of work, activity, or objective that may be completed in furtherance of a project. In some embodiments, projects include development of hardware, software, firmware, and/or the like. In various embodiments, a project is associated with a plurality of resources that may be used or consumed to complete or maintain the project. In some embodiments, a project is associated with one or more requirements. In various embodiments, a project is associated with one or more profiles comprising data associated with the project. For example, a profile of a project may include project design electronic records, resource impact value electronic records (e.g., a resource cost electronic record), project proposal electronic records, project requirement electronic requirement records, and/or the like. In this manner, a respective profile may embody or comprise project designs, project requirements, project proposals, resource impact values (e.g., resource cost), and/or the like.

As used herein, the term “resource” refers to an allocatable entity that may contribute to a project, or task thereof. In various embodiments, resources include computing resources, personnel, equipment, facilities, and/or the like.

As used herein, the term “parameter” includes any property, characteristic, or criteria associated with a project, a resource, and/or the like. For example, parameters of a project may include project proposals, project specifications, project requirements, resource impact value records, and/or the like. As another example, parameters of a resource include impact value, availability, stability, performance, quality, and/or the like.

As used herein, the term “requirement” refers to any rule, policy, constraint, requirement, and/or the like that is to be satisfied by a project and/or must be met in order to implement a project. For example, requirements may include rules or policies pursuant to projects impact values, resources, performance, timeliness, scope, safety, quality, and/or the like. In some embodiments, a requirement may be referred to as a requirement feature.

As used herein, the term “dataset” includes any data that is associated with a project. For example, a dataset may include project documentation electronic records, project-related communications, project resource information, project customer information, and/or the like.

As used herein, the term “data object” refers to any digital representation of information that characterizes or describes one or more aspects of a project. For example, a data object may include digital files (e.g., documents, images, videos, audio, and/or the like) that represent project designs, project resources, project proposals, project requirements, customer requests, project objectives, and/or the like.

As used herein, the term “natural language” refers to textual information, or an utterance of textual information, intelligible to human users and in accordance with parlance of the human users. For example, natural language may comprise a body of textual content that defines a grammatically accurate and typographically correct series of phrases, sentences, paragraphs, and/or the like.

As used herein, the term “natural language input” refers to textual information that originates from one or more inputs of a human user. For example, natural language input may include textual content that is inputted by a user into a computing device. As another example, a natural language input may include recorded human speech based upon which textual information may be generated.

As used herein, the term “prompt” refers to a natural language text that requests a machine learning model to perform one or more tasks. For example, a natural language instruction may comprise natural language text that requests a large language model to generate, modify, or transmit a project proposal, project specification, resource impact value record, and/or the like.

As used herein, the term “natural language output” refers to natural language text that is generated by a machine learning model. For example, a natural language output may comprise output of an LLM. In some embodiments, natural language output includes non-textual content outputted by a generative AI model. For example, natural language output may include natural language text generated by an LLM, and one or more images generated by an image generation model. As another example, natural language output may include utterances of natural language text, such as in the form of computer voice-based audio.

As used herein, the term “electronic record” refers to any computer-coded representation of information. For example, an electronic record may include document files, image files, video files, three-dimensional design files, audio files, and/or the like, comprising project-related information, resource-related information, and/or the like.

As used herein, the term “embedding” refers to a numerical representation of data in one or more dimensions. For example, an embedding may include a vector representation of a natural language input that enables consumption of the natural language input by machine learning models.

As used herein, the term “machine learning model” refers to any algorithmic and/or machine learning model that comprises hardware and/or software that generates text, images, videos, or other data based at least in part on one or more instructions provided in a natural language format. In some embodiments, a machine learning model includes one or more large language models (LLMs) including autoregressive language models, autoencoding language models, and/or the like. Additionally, or alternatively, in some embodiments, a machine learning model comprises an architecture based at least in part on generative adversarial networks (GANs), variational autoencoders (VAEs), autoregressive models, recurrent neural networks (RNNs), transformers, image generators, and/or the like. In various embodiments, a machine learning model is configured to perform retrieval-augmented generation (RAG) techniques to enhance, expand, or augment data that is consumed by the machine learning model to generate an output based on one or more input instructions. In some embodiments, a machine learning model includes one or more attention mechanisms that enable a machine learning model to weight the respective influence or contribution of subsets of input data. In various embodiments, attention mechanisms include self-attention, scaled dot-product attention, multi-head attention, location-based attention, and/or the like. In some embodiments, machine learning model comprises a plurality of layers with each layer configured to perform one or more operations described herein. For example, a first layer of the plurality of layers may be configured to generate at least one data object. As another example, a second layer may be configured to generate at least one natural language output based on the at least one data object generated by the first layer of the plurality of layers.

### Overview

Example embodiments disclosed herein address technical problems associated with systems, apparatuses, methods, and computer program products for project program generation. As would be understood by one skilled in the field to which this disclosure pertains, there are numerous example scenarios in which systems, apparatuses, methods, and computer program products for project program generation.

Project program generation typically involves communication and coordination amongst hundreds to thousands of entities to develop and finalize designs, determine requisite components, and conduct procurement. The impact value of any given part or service may determine the ability to execute a project in accordance with target objectives, such as total resource utilization, timeliness, and quality. For example, technical projects may require identification and procurement of tens of thousands of parts and services. Parts and services procurement may require sourcing numerous proposals from suppliers, vetting the proposals to determine a final supplier, and communicating with approved suppliers to ensure parts and services are provided as scheduled and in accordance with project specifications. Part and service providers may demonstrate varying levels of quality, cost, stability, deliverability, and/or the like. Further, projects may be subject to internal or external policies related to where parts and services may be obtained. Thus, effective project program generation may require coordination and communication between a diffuse set of internal stakeholders and external providers to ensure that project resources are optimally sourced.

To address these challenges, and others, the systems, apparatuses, methods, and computer program products provide an automated architecture to obtain program data and generate predictive outputs indicative of programs with optimal impact value to a project. For example, the systems, apparatuses, methods, and computer program products may automatically correlate and query program data based on project data to determine one or more optimal part providers, services, and/or the like for meeting project resource objectives. In various embodiments, the automation techniques described herein enable analysis of program impact value at scale and depth, such as in projects involving tens of thousands of parts and where a given part may be sourced from tens to hundreds of diffuse sources. In this manner, the described techniques may enhance project quality by automating operations of program generation and selection, optimizing resource impact values and providing efficiency, scalability, and adaptability to the project. For example, existing approaches typically rely upon manual review to source and evaluate programs, reducing efficiency and accuracy due to the large volumes of program data and performance limitations of human processing. Additionally, program data for the diffuse network of program providers may be distributed across hundreds to thousands of databases, and manual approaches may be incapable of timely and efficiently accessing, aggregating, and correlating data.

Thus, to address these and/or other issues related to such example solutions, example systems, apparatuses, methods, and computer program products for project program generation are disclosed herein.

Further embodiments and advantages of the example systems, apparatuses, methods, and computer program products disclosed herein are described in the following co-pending U.S. patent applications: U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”; U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,892, titled “SYSTEMS, APPARATUSES, METHODS, AND COMPUTER PROGRAM PRODUCTS FOR AUTOMATED PROJECT QUALITY CONTROL”; and U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products for automated project program generation. It should be readily appreciated that the embodiments of the apparatus, systems, methods, and computer program product described herein may be configured in various additional and alternative manners in addition to those expressly described herein.

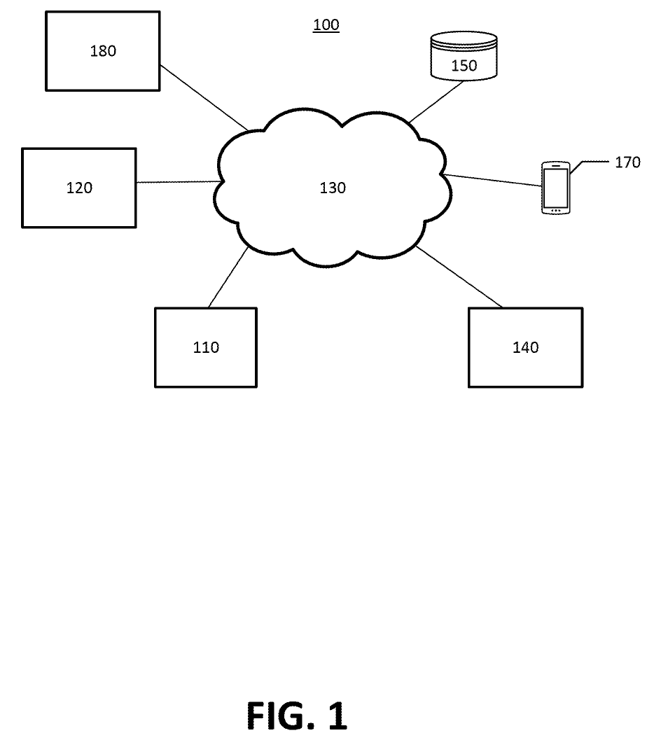

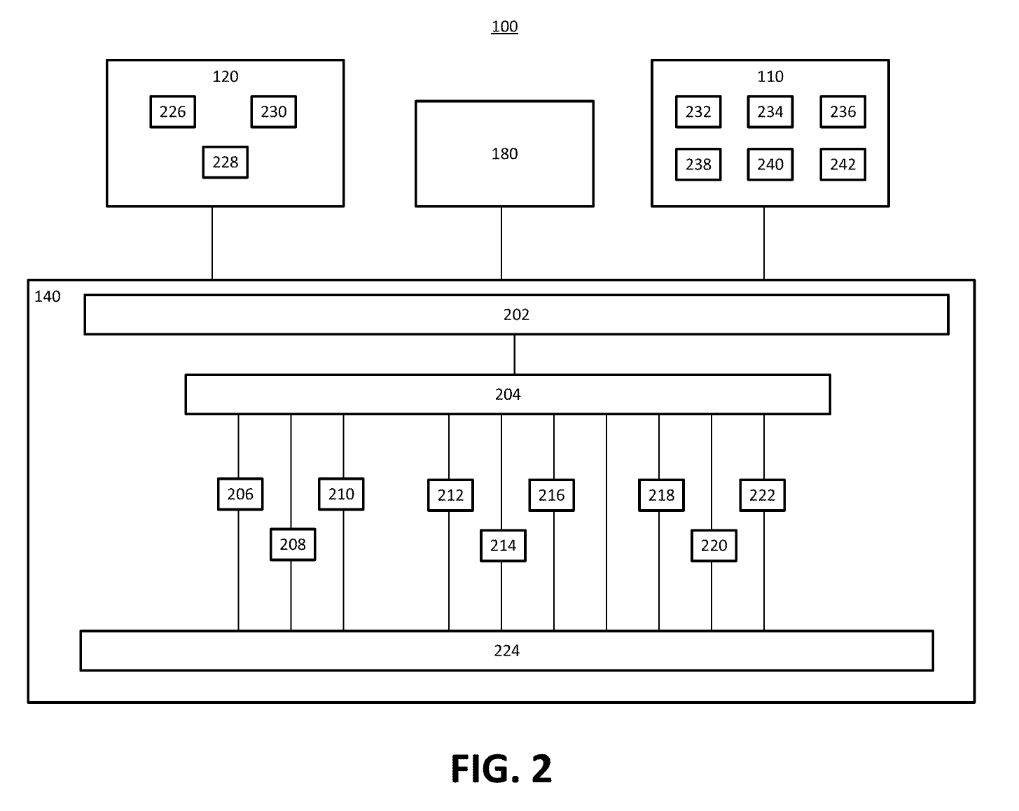

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

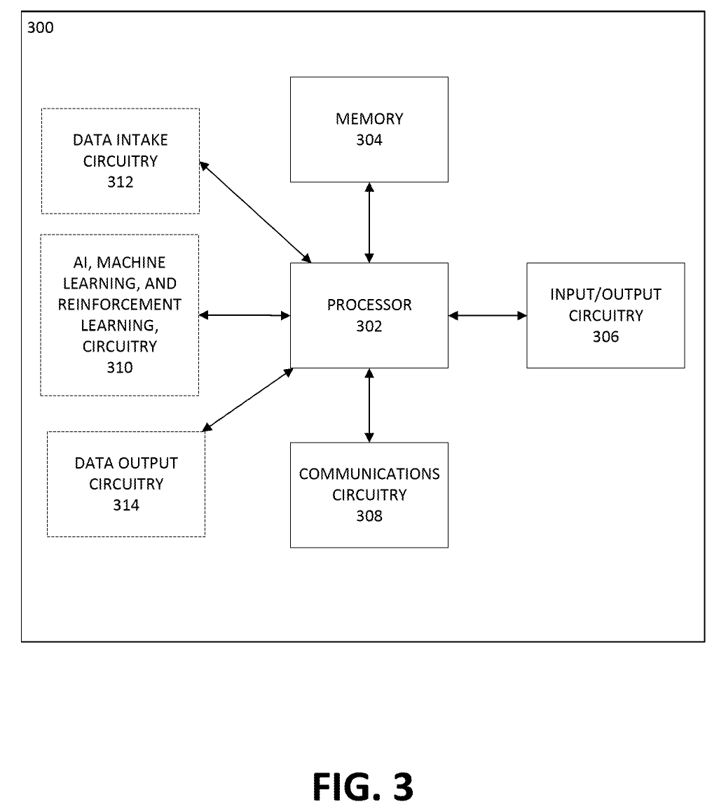

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

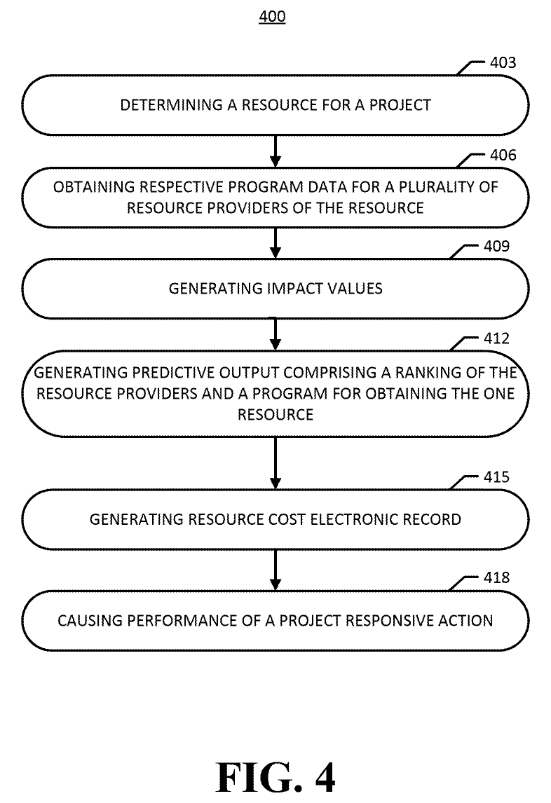

In various embodiments, the project foundation device 180, the external project implementation device 120, the external project application device 110, the cloud-based project operations device 140, and/or the like is/are configured to carry out functionality for generating project programs including determining program providers for project resources. For example, the project foundation device 180, the external project implementation device 120, the external project application device 110, the cloud-based project operations device 140, and/or the like may perform, via one or more apparatuses 300, the method 400 as shown in FIG. 4 and described herein to generate and provision to a computing device an indication of a ranking of resource providers and a program for obtaining one or more resources from a top-ranked resource provider. In doing so, the project foundation device 180, the external project implementation device 120, the external project application device 110, the cloud-based project operations device 140, and/or the like may automate project program generation, enabling efficient procurement of project resources at scale. In some, elements of the cloud-based project operations device 140 that carry out the described functionality and operations include the inventory predictive computing entity 206, project component engineering predictive computing entity 214, project operations predictive computing entity 220, and/or the like. Additionally, or alternatively, in some embodiments, elements of the external project application device that carry out and/or support the described functionality and operations include the project impact value computing application 234, project documentation computing application 236, project component computing application 238, and/or the like.

In some embodiments, the project foundation device 180, the external project implementation device 120, the external project application device 110, the cloud-based project operations device 140, and/or the like generates impact values that are representative of the quality of a program for providing a resource. For example, one or more impact values may provide a qualitative or quantitative performance measure of a program according to one or more categories including resource cost, resource quality, resource delivery accuracy, provider stability, resource availability, provider communication, historical resource performance, internal or external project policy compliance, and/or the like. In this manner, the project foundation device 180, the external project implementation device 120, the external project application device 110, the cloud-based project operations device 140, and/or the like may estimate the quality or suitability of a program and associated resource provider. In various embodiments, the project foundation device 180, the external project implementation device 120, the external project application device 110, the cloud-based project operations device 140, and/or the like generates, via one or more machine learning models, a predictive output based at least in part on the impact values. In some embodiments, the predictive output comprises a ranking of resource providers based at least in part on the respective impact scores for each resource provider and the program for procuring the resource from the resource provider. The predictive output may further comprise a program for obtaining the resource, and the program may be associated with the top-ranked provider from the ranking. Additionally, or alternatively, in some embodiments, the predictive output comprises a ranking of the programs of the plurality of providers for the resource.

In some embodiments, the project foundation device 180, the external project implementation device 120, the external project application device 110, the cloud-based project operations device 140, and/or the like provides an indication of one or more rankings and the optimal determined program to one or more user devices 170. For example, the project foundation device 180, the external project implementation device 120, the external project application device 110, the cloud-based project operations device 140, and/or the like may cause rendering of a graphical user interface (GUI) on a display of the user device 170. The GUI may comprise, for example, an indication of a top-ranked resource provider and the corresponding program for providing the resource. In some embodiments, the project foundation device 180, the external project implementation device 120, the external project application device 110, the cloud-based project operations device 140, and/or the like also provisions and/or renders on the GUI the one or more impact values associated with the resource provider and program. For example, the impact values be displayed in a GUI contextualized with threshold impact values associated with the project or averaged impact values derived from all evaluated resource providers.

In some embodiments, the project foundation device 180, the external project implementation device 120, the external project application device 110, the cloud-based project operations device 140, and/or the like detects one or more changes to program data for one or more resource providers. In response to detecting the change, the cloud-based project operations the project foundation device 180, the external project implementation device 120, the external project application device 110, the cloud-based project operations device 140, and/or the like may generate new or update existing impact values for the resource provider. In some embodiments, the project foundation device 180, the external project implementation device 120, the external project application device 110, the cloud-based project operations device 140, and/or the like generates a new predictive outcome based at least in part on the additional impact values. In doing so, the cloud-based project operations device 140 may dynamically identify and alert to changes in programs for providing resources. In this manner, the cloud-based project operations device 140 may indicate possible opportunities to further optimize resource procurement throughout the product lifecycle.

In various embodiments, the project foundation device 180, the external project implementation device 120, the external project application device 110, the cloud-based project operations device 140, and/or the like train and execute machine learning models, such as large language models (LLMs), to generate predictive outputs by resource procurement and optimization may be performed. In this manner, the described techniques may provide precise real-time human-machine interfaces for determining optimal resource providers and programs for obtaining resources therefrom. In some embodiments, the project foundation device 180, the external project implementation device 120, the external project application device 110, the cloud-based project operations device 140, and/or the like train LLMs based at least in part on user inputs, such as acceptance or rejection of a program for obtaining a resource from a particular resource provider.

For example, the project foundation device 180, the external project implementation device 120, the external project application device 110, the cloud-based project operations device 140, and/or the like may obtain from user input one or more modifications to a resource program and/or resource provider ranking generated using an LLM. The project foundation device 180, the external project implementation device 120, the external project application device 110, the cloud-based project operations device 140, and/or the like may modify the resource program, or the ranking of resource providers based at least in part on the user input. Further, the project foundation device 180, the external project implementation device 120, the external project application device 110, the cloud-based project operations device 140, and/or the like may retrain the LLM and/or other models used to generate predictive output based at least in part on the user input, the modified resource program, the modified ranking, and/or the like. In doing so, the project foundation device 180, the external project implementation device 120, the external project application device 110, the cloud-based project operations device 140, and/or the like may provide advantages including increasing the accuracy and quality of resource procurement programs, customizing the style, composition, and/or selection of resource programs in accordance with user or customer objectives. In some embodiments, the user input includes one or more selections for impact values that may be prioritized when generating resource provider rankings and programs. For example, the user input may include a selection to prioritize availability metrics over resource costs, stability metrics over availability metrics, or quality metrics over duty metrics and transportation metrics. In this manner, generative machine learning processes may be optimized based at least in part on configuration of weights applied to different types of impact values.

In some embodiments, the project foundation device 180, the external project implementation device 120, the external project application device 110, the cloud-based project operations device 140, and/or the like, trains and store multiple different instances of an LLM. The multiple instances of the LLM may be associated with different users, customers, project types, resource types, and/or the like. In doing so, the project foundation device 180, the external project implementation device 120, the external project application device 110, the cloud-based project operations device 140, and/or the like may generate, train, and maintain instances of an LLM that are customized in accordance with preferences or requires of the associated user, customer, project type, resource type and/or the like. In some embodiments, the project foundation device 180, the external project implementation device 120, the external project application device 110, the cloud-based project operations device 140, and/or the like may determine whether to cross-train or otherwise update other instances of the LLM based on a particular LLM. For example, the project foundation device 180, the external project implementation device 120, the external project application device 110, the cloud-based project operations device 140, and/or the like may be configured to determine whether a user inputted modification, based on which one instance of an LLM is retrained, may be utilized as a basis for training other instances of the LLM.

In some embodiments, the determination of whether to cross-train or update other instances of the LLM is based on an analysis of the user input, modification, and/or the like, which may be performed at least in part using machine learning techniques, such as reinforcement learning. For example, the project foundation device 180, the external project implementation device 120, the external project application device 110, the cloud-based project operations device 140, and/or the like may determine whether a user input, modification, and/or the like is associated with effecting a subjective change (e.g., accommodating stylistic preferences) or an objective change (e.g., correcting for compositional or structural errors). In this manner, the project foundation device 180, the external project implementation device 120, the external project application device 110, the cloud-based project operations device 140, and/or the like may train a plurality of instances of LLMs in a federated manner, distributing or siloing model updates based on analyses of the conditions arising to the modifications to a model instance.

In some embodiments, the project foundation device 180, the external project implementation device 120, the external project application device 110, the cloud-based project operations device 140, and/or the like process natural language inputs from a user entity to determine one or more intents of the user entity, including requests, adjustments, approvals, rejections, and/or the like. For example, the project foundation device 180, the external project implementation device 120, the external project application device 110, the cloud-based project operations device 140, and/or the like may execute one or more machine learning models on input derived from or comprising a natural language-based user input. In doing so, the project foundation device 180, the external project implementation device 120, the external project application device 110, the cloud-based project operations device 140, and/or the like may obtain as output approval or disapproval of resource cost electronic records, requests to apply one or more criteria to a processes for generating an optimal resource procurement program, modifications to resource provider rankings, impact values, project requirements, and/or the like.

In some embodiments, the project foundation device 180, the external project implementation device 120, the external project application device 110, the cloud-based project operations device 140, and/or the like generate, using one or more machine learning models, one or more embeddings based at least in part on natural language inputs. For example, the project foundation device 180, the external project implementation device 120, the external project application device 110, the cloud-based project operations device 140, and/or the like may generate vector representations of terms in a natural language input, or subsets thereof.

In some embodiments, the project foundation device 180, the external project implementation device 120, the external project application device 110, the cloud-based project operations device 140, and/or the like generate, using one or more machine learning models, one or more embeddings based at least in part on electronic records associated with a project, such as project proposal electronic records, project documentation electronic records, project requirement electronic records, project design electronic records, and/or the like. For example, the project foundation device 180, the external project implementation device 120, the external project application device 110, the cloud-based project operations device 140, and/or the like may generate a plurality of embeddings based at least in part on one or more project documentation records, project requirement electronic records, and/or the like. The project foundation device 180, the external project implementation device 120, the external project application device 110, the cloud-based project operations device 140, and/or the like may determine one or more project requirements based at least in part on the embeddings. The project foundation device 180, the external project implementation device 120, the external project application device 110, the cloud-based project operations device 140, and/or the like may use the one or more project requirements as an input or constraint to machine learning processes for generating an optimal program to obtain a resource from one of a plurality of resource providers.

In various embodiments, the project foundation device 180, the external project implementation device 120, the external project application device 110, the cloud-based project operations device 140, and/or the like, generates, via a respective attention mechanism of one or more machine learning models, a plurality of attention weights associated with different subsets of a natural language input, an electronic record, and/or the like. The attention weights may determine the relative contribution or importance attributed to the associated element when generating a machine learning output. For example, attention weights may be utilized by an LLM to prioritize subsets of a natural language input or other model input when generating impact values, rankings of resource providers, programs for obtaining resources, natural language outputs, and/or the like. In some embodiments, the project foundation device 180, the external project implementation device 120, the external project application device 110, the cloud-based project operations device 140, and/or the like are configured to perform one or more retrieval-augmented generation (RAG) techniques based at least in part on model inputs and associated attention weights to determine additional relevant data that may be consumed as input by a machine learning model.

In some embodiments, the project foundation device 180, the external project implementation device 120, the external project application device 110, the cloud-based project operations device 140, and/or the like generate impact values, rankings of resource providers, programs for obtaining resources, and/or the like via one or more machine learning models. For example, the project foundation device 180, the external project implementation device 120, the external project application device 110, the cloud-based project operations device 140, and/or the like may generate predictive outputs comprising resource provider rankings and programs for optimally obtaining a resource from a resource provider based at least in part on execution of an LLM on input comprising respective program data for a plurality of resource providers. In this manner, the project foundation device 180, the external project implementation device 120, the external project application device 110, the cloud-based project operations device 140, and/or the like may automate processes for determining strategies for procuring resources, enabling optimization of the program based on resource cost, resource quality, resource availability, resource provider stability, transportation cost, policy impact (e.g., duties, tariffs, documentation, and/or the like).

In various embodiments, the project foundation device 180, the external project implementation device 120, the external project application device 110, the cloud-based project operations device 140, and/or the like generate natural language outputs, electronic records, and/or the like that may be rendered on GUIs, enabling user entities to view and respond to the digital content. For example, the project foundation device 180, the external project implementation device 120, the external project application device 110, the cloud-based project operations device 140, and/or the like may generate and update a GUI based at least in part on one or more predictive outputs comprising real-time rankings of providers for a resource and a current or forecasted program for optimally obtaining the resource from a top-ranked provider. The project foundation device 180, the external project implementation device 120, the external project application device 110, the cloud-based project operations device 140, and/or the like may generate resource cost electronic records based at least in part on the predictive output and, on the GUI, cause rendering of a media element representing the resource cost electronic record. In doing so, the project foundation device 180, the external project implementation device 120, the external project application device 110, the cloud-based project operations device 140, and/or the like may receive additional user input embodying a qualitative assessment of and/or modification to the resource cost electronic record, such as approval, adjustment, rejection, and/or the like of the program for obtaining the resource or associated resource provider.

In various embodiments, the project foundation device 180, the external project implementation device 120, the external project application device 110, the cloud-based project operations device 140, and/or the like carries out additional functionality based at least in part on the resource cost electronic record, such as causing performance of one or more project responsive actions. For example, the project foundation device 180, the external project implementation device 120, the external project application device 110, the cloud-based project operations device 140, and/or the like may cause provision of the resource cost electronic record to one or more computing devices. As another example, the project foundation device 180, the external project implementation device 120, the external project application device 110, the cloud-based project operations device 140, and/or the like may initiate the generated program for obtaining a resource from one of a plurality of resource providers. As another example, the project foundation device 180, the external project implementation device 120, the external project application device 110, the cloud-based project operations device 140, and/or the like may generate one or more adjustments to a project proposal electronic record or project design electronic record, such as one or more modifications to a timeline for completing tasks associated with the resource. As another example, the project foundation device 180, the external project implementation device 120, the external project application device 110, the cloud-based project operations device 140, and/or the like may determine that an optimal program for obtaining a resource fails to satisfy one or more predetermined criteria (e.g., resource cost budget, resource availability threshold, provider stability threshold, resource delivery threshold, policy compliance, and/or the like). In response, the project foundation device 180, the external project implementation device 120, the external project application device 110, the cloud-based project operations device 140, and/or the like may provision an alert to one or more computing devices. In this manner, the project foundation device 180, the external project implementation device 120, the external project application device 110, the cloud-based project operations device 140, and/or the like may automate project program generation and monitoring, increasing efficiency and stability of project program implementation.

### Example Methods

Referring now to FIG. 4, a flowchart providing an example method 800 is illustrated. In this regard, FIG. 4 illustrates operations that may be performed by the project foundation device 180, the external project implementation device 120, the external project application device 110, the cloud-based project operations device 140, the one or more databases 150, and/or the user device 170. To describe example aspects of the method 400, the proceeding description is presented in the context of the cloud-based project operations device 140. In some embodiments, one or more operations of the method 400 are performed instead by the project foundation device 180, the external project implementation device 120, the external project application device 110, the one or more databases 150, and/or the user device 170.

In some embodiments, the method 400 comprises operations for determining one or more resources based at least in part on user input or a project proposal electronic record, obtaining respective program data for a plurality of resource providers based on the resource, generating impact values for the resource providers based on the respective program data, generating, based at least in part on the impact values, predictive output comprising a ranking of the resource providers and a program for obtaining the at least one resource, generating a resource cost electronic record based at least in part on the predictive output, and causing performance of one or more project responsive actions based at least in part on the resource cost electronic record. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400.

In some embodiments, at operation 403, the method 400 includes determining one or more resources for a project. For example, the method 400 may include determining the resource based at least in part on a project proposal electronic record, project design electronic record, project documentation electronic record, project requirement electronic record, user input, and/or the like. In some embodiments, the method 400 includes generating a plurality of embeddings representing subsets of user input, one or more electronic records, and/or the like. For example, the method 800 may include generating, using one or more machine learning models, a plurality of embeddings that represent respective subsets of the natural language of a user input, textual content of a project documentation electronic record, textual content of a project requirement electronic record, and/or the like. In various embodiments, the method 400 includes determining the resource based at least in part on the plurality of embeddings. For example, the method 400 may include determining the resource using one or more machine learnings configured to predict a resource based at least in part on the plurality of embeddings. In some embodiments, the method 400 includes receiving a user input comprising a selection of one or more resource identifiers rendered on a GUI. The resource may be determined based at least in part on the selection.

In some embodiments, at operation 406, the method 400 includes obtaining, from a plurality of data sources, respective program data for a plurality of resource providers for the resource. In some embodiments, the data sources include external project application devices 110, external project implementation devices 120, project foundation devices 180, databases 150, user devices 170, and/or the like. In various embodiments, the program data for a resource provider includes one or more properties of the resource provider including provider location, resource cost, predicted transportation cost, historical resource transportation data (e.g., historical transportation costs, intervals, and/or the like), historical provider stability data (e.g., reliability of cost estimates, transportation estimates, and/or the like), resource inventory data (e.g., current or forecasted availability of a resource, resource configuration options, and/or the like), policy compliance data (e.g., applicable duties, tariffs, sanctions, environmental standards, and/or the like), historical resource quality data, and/or the like.

In some embodiments, at operation 409, the method 400 includes generating a respective impact value for the plurality of resource providers based at least in part on the program data that is associated with the resource provider. In some embodiments, the impact values include one or more availability metrics, resource costs, stability metrics, quality metrics, duty metrics, transportation metrics, and/or the like. In some embodiments, an availability metric indicates an amount of a resource that is immediately accessible from an existing supply (e.g., which may be a supply of a customer, the project responsible entity, and/or the like). Alternatively, or additionally, in some embodiments, an availability metric indicates a quantity of a resource that may be obtained from a resource provider (e.g., immediately or at a time interval). In some embodiments, a resource cost indicates a monetary value associated with acquiring a resource from a resource provider. A resource cost may include a plurality of monetary values in accordance with acquiring different amounts of the resource. A resource cost may include a plurality of monetary values associated with acquiring a resource in accordance with transportation metrics, quality metrics, duty metrics, and/or the like. In some embodiments, a stability metric indicates historical performance of a resource provider in providing a resource in accordance with forecasted or agreed upon costs, transportation intervals, and/or the like. For example, a stability metric may include one or more values that quantify a reliability or timeliness of the resource provider. In some embodiments, a quality metric indicates whether or to what degree a resource obtained from a resource provider satisfies one or more quality criteria. For example, a quality metric may include one more values indicative of the historical performance or historical properties of a resource obtained from a particular resource provider. In this manner, a quality metric may indicate whether or to what degree the output of a resource provider demonstrates satisfactory performance, defects, breakage, spoiling, and/or the like.

In some embodiments, a duty metric indicates whether one or more external procurement policies apply to obtaining a resource from a particular resource provider (e.g., based on provider location, national or subnational affiliation, and/or the like). For example, a duty metric may indicate whether procurement of a resource from a resource provider will trigger duties, tariffs, or other taxes. As another example, a duty metric may indicate whether procurement of the resource from the resource provider is permissible. In some embodiments, the duty metric includes one or more estimated values of duties, tariffs, or other costs associated with policy compliance. For example, the duty metric may include an estimated tariff associated with procuring a resource from a resource provider in a particular location or of a particular affiliation. In some embodiments, a transportation metric indicates an estimated cost of delivery for a resource. A transportation metric may include multiple values associated with the cost of delivery of different amounts of a resource, different delivery schedules, different delivery locations, and/or the like.

In some embodiments, the impact values are based at least in part on an absolute scale or relation to one or more predetermined thresholds. Alternatively, or additionally, in some embodiments, the impact values are comparative metrics generated based at least in part on respective differences between two or more resource providers. In various embodiments, the method 400 includes obtaining program data and updating impact values in real-time. In this manner, factors impacting resource procurement may be iteratively assessed as changes occur, and resource procurement programs may be generated or modified to optimize for current conditions. For example, method 400 may include detecting a change to the respective program data for a resource provider, and updating one or more impact values for the resource provider based at least in part on the change to the respective program data. The method 400 may further include generating, based at least in part on the updated impact value, a second predictive output comprising a second ranking of a plurality of resource providers and an indication of a second program for obtaining the resource. The method 400 may further include modifying a previously generated resource cost electronic record based at least in part on the second predictive output and one or more impact values associated with a top-ranked entry of the second ranking (e.g., which may be different from a top-ranked entry of an initial ranking of the plurality of resource providers). The method 400 may further include adjusting, based at least in part on the modified resource cost electronic record, the performance of one or more project responsive actions. Additionally, or alternatively, the method 400 may include causing performance of additional project responsive actions based at least in part on the modified resource cost electronic record.

In some embodiments, at operation 412, the method 400 includes generating a predictive output based at least in part on the respective impact values of the plurality of resource providers. Additionally, the method 400 may include generating a predictive output based at least in part on the impact values and one or more project requirements, such as task completion thresholds, resource budget thresholds, resource delivery thresholds, resource quality criteria, and/or the like. In some embodiments, the method 400 includes generating the predictive output based at least in part on natural language (or embeddings thereof) obtained via user input. For example, the natural language may define targets, constraints, objectives, and/or the like, that are applicable to the procurement of a resource. In various embodiments, the method 400 includes generating the predictive output using one or more machine learning models. For example, the method 400 may include generating a predictive output based at least in part on the respective impact values and using one or more large language models (LLMs).

In some embodiments, the predictive output includes a ranking of the plurality of resource providers, where a top-ranked entry of the ranking is associated with one of the plurality of resource providers that is predicted to be most optimal for providing the resource. In various embodiments, the predictive output includes an indication of a program for obtaining the resource. The program may be based at least in part on the ranking of the plurality of providers and may comprise one or more impact values associated with the top-ranked entry of the ranking. In various embodiments, the program for obtaining the resource is configured to optimize one or more factors including cost of the resource, predicted interval for receiving the resource, quality of the resource, stability of the resource provider, and/or the like. In some embodiments, the program includes one or more metrics associated with obtaining the resource from the resource provider. For example, the program may include resource costs, delivery costs, delivery timelines, available inventory, applicable duties or other policy-associated costs, historical quality metrics, provider stability metrics, and/or the like.

In some embodiments, at operation 415, the method 400 includes generating a resource cost electronic record based at least in part on the predictive output. For example, the method 400 includes generating, using a project record predictive computing entity 212, one or more resource cost electronic records based at least in part on the ranking of the resource providers and the program for obtaining the resource. In various embodiments, the resource cost electronic record includes one or more metrics associated with the program for obtaining the resource. For example, the resource cost electronic record may include metrics for resource cost, resource availability, resource quality, resource transportation, costs associated with policy compliance, and/or the like. In some embodiments, the resource cost electronic record includes information identifying the resource provider predicted to be most optimal for providing the resource. In some embodiments, the resource cost electronic record includes additional entries from the ranking of the plurality of resource providers. In some embodiments, the resource cost electronic record includes respective impact values of one or more resource providers.

In some embodiments, the method 400 includes generating a natural language output based at least in part on the predictive output, the resource cost electronic record, the impact values and/or the like. For example, the method 800 may include generating, using the project orchestration predictive computing entity 204, a natural language output comprising a description of the program for obtaining the resource, a description of the top-ranked resource provider, a description of one or more impact values, and/or the like. In some embodiments, the natural language output includes one or more user-directed queries regarding aspects of the program, such as whether to adjust the program or generate a second predictive output that prioritizes one or more types of impact values (e.g., cost, quality, stability, policy compliance, and/or the like). In some embodiments, the method 400 includes generating the natural language output using one or more machine learning models, such as one or more LLMs. For example, the method 400 may include generating, using an LLM, a natural language output based at least in part on the predictive output, the resource cost electronic record, the impact values and/or the like.

In some embodiments, at operation 418, the method 400 includes causing performance of one or more project responsive actions based at least in part on the resource cost electronic record, the predictive output, one or more impact values, and/or the like. For example, the method 400 may include initiating the program for obtaining the resource from one of the plurality of resource providers, such as by provisioning a request for the resource to the resource provider. As another example, the method 400 may include provisioning the resource cost electronic record to one or more computing devices, such as an external project application device 110, an external project implementation device 120, a project foundation device 180, a user device 170, and/or the like. In some embodiments, the method 400 includes receiving from the computing device an approval of the resource cost electronic record and/or program for obtaining the resource. The method 400 may include, in response to the approval, provisioning the resource cost electronic record to one or more additional computing devices. For example, in response to receiving approval of the resource cost electronic record from a user device 170, external project application device 110, external project implementation device 120, and/or the like, provisioning the resource cost electronic record to a project foundation device 180 and/or computing device associated with the top-ranked resource provider.

In various embodiments, the method 400 includes causing rendering of a GUI comprising the resource cost electronic record on a display of one or more computing devices, such as an external project application device 110, an external project implementation device 120, a project foundation device 180, a user device 170, and/or the like. In some embodiments, the method 400 includes receiving one or more user inputs comprising natural language configured for adjusting the resource cost electronic record. For example, the method 400 may include receiving, from a user device 170, natural language defining an instruction to prioritize of a subset of impact value types (e.g., cost, quality, stability, and/or the like), and to modify the program for obtaining the resource in accordance with the prioritization. The method 400 may include applying one or more weight values to the impact values of the resource providers in accordance with the instruction. The method 400 may include generating a second predictive output based at least in part on the weighted impact values. The method 400 may include generating a new resource cost electronic record or updating an existing resource cost electronic record based at least in part on the second predictive output. The method 400 may include performing one or more additional project responsive actions based at least in part on the new or updated resource cost electronic record.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
determining at least one resource for a project based at least in part on at least one of a user input or a project proposal electronic record;
obtaining respective program data from a plurality of data sources based at least in part on the at least one resource, wherein the respective program data is associated with one of a plurality of resource providers for the at least one resource;
generating at least one impact value for the plurality of resource providers based at least in part on the respective program data;
generating, based at least in part on the at least one impact value of the plurality of resource providers, a predictive output comprising:
a ranking of the plurality of resource providers; and
an indication of a program for obtaining the at least one resource, wherein the program is based at least in part on a top-ranked entry of the ranking and comprises the at least one impact value associated with the top-ranked entry of the ranking;
generating a resource cost electronic record based at least in part on the predictive output and the at least one impact value associated with the top-ranked entry of the ranking; and
causing performance of at least one project responsive action based at least in part on the resource cost electronic record.

2. The method of claim 1, wherein:
the at least one impact value comprises at least one availability metric associated with the at least one resource.

3. The method of claim 1, wherein:
the at least one impact value comprises at least one resource cost associated with the at least one resource.

4. The method of claim 1, wherein:
the at least one impact value comprises a stability metric associated with the resource provider.

5. The method of claim 1, wherein:
the at least one impact value comprises a quality metric associated with the resource provider.

6. The method of claim 1, wherein:
the at least one impact value comprises at least one duty metric associated with at least one of the at least one resource or the resource provider.

7. The method of claim 1, wherein:
the at least one impact value comprises at least one transportation metric associated with at least one of the at least one resource or the resource provider.

8. The method of claim 1, wherein:
the performance of the at least one project responsive action comprises:
provisioning the resource cost electronic record to at least one computing device.

9. The method of claim 8, further comprising:
in response to receiving from the at least one computing device, an approval of the program for obtaining the at least one resource, provisioning to a second computing device a resource request configured in accordance with the program for obtaining the at least one resource, wherein:
the second computing device is associated with the top-ranked entry of the ranking.

10. The method of claim 1, further comprising:
detecting at least one change to the respective program data for at least one of the plurality of resource providers;
updating the at least one impact value for the at least one of the plurality of resource providers based at least in part on the at least one change to the respective program data;
generating, based at least in part on the at least one updated impact value, a second predictive output comprising a second ranking of the plurality of resource providers and an indication of a second program for obtaining the at least one resource; and
modifying the resource cost electronic record based at least in part on the second predictive output and the at least one impact value associated with the top-ranked entry of the second ranking.

11. The method of claim 10, further comprising at least one of the following:
adjusting, based at least in part on the modified resource cost electronic record, the performance of the at least one project responsive action; or
causing performance of a second project responsive action based at least in part on the modified resource cost electronic record.

12. An apparatus comprising memory and one or more processors communicatively coupled to the memory, the one or more processors configured to perform operations comprising:
determining at least one resource for a project based at least in part on at least one of a user input or a project proposal electronic record;
obtaining respective program data from a plurality of data sources based at least in part on the at least one resource, wherein the respective program data is associated with one of a plurality of resource providers for the at least one resource;
generating at least one impact value for the plurality of resource providers based at least in part on the respective program data;
generating, based at least in part on the at least one impact value of the plurality of resource providers, a predictive output comprising:
a ranking of the plurality of resource providers; and
an indication of a program for obtaining the at least one resource, wherein the program is based at least in part on a top-ranked entry of the ranking and comprises the at least one impact value associated with the top-ranked entry of the ranking;
generating a resource cost electronic record based at least in part on the predictive output and the at least one impact value associated with the top-ranked entry of the ranking; and
causing performance of at least one project responsive action based at least in part on the resource cost electronic record.

13. The apparatus of claim 12, wherein:
the plurality of data sources comprises a plurality of external project application devices.

14. The apparatus of claim 12, wherein:
the plurality of data sources comprises a plurality of external project implementation devices.

15. The apparatus of claim 12, wherein:
the one or more processors are further configured to perform operations comprising:
determining at least one project requirement based at least in part on at least one of the following:
at least one project documentation electronic record; or
at least one project requirement electronic record; and
determining the at least one resource for the project based at least in part on the at least one project requirement.

16. The apparatus of claim 12, wherein:
the one or more processors are further configured to perform operations comprising:
causing rendering of a graphical user interface (GUI) on a display of at least one computing device, the GUI being representative of the resource cost electronic record.

17. The apparatus of claim 12, wherein:
the one or more processors are configured to generate the predictive output using at least one machine learning model.

18. The apparatus of claim 17, wherein:
the at least one machine learning model comprises at least one large language model (LLM).

19. The apparatus of claim 12, wherein:
the program for obtaining the at least one resource is configured to optimize a cost of the at least one resource and a predicted interval for receiving the at least one resource.

20. A computer program product comprising at least one non-transitory computer-readable storage medium having computer program code stored thereon that, in execution with at least one processor, configures the computer program product for:
determining at least one resource for a project based at least in part on at least one of a user input or a project proposal electronic record;
obtaining respective program data from a plurality of data sources based at least in part on the at least one resource, wherein the respective program data is associated with one of a plurality of resource providers for the at least one resource;
generating at least one impact value for the plurality of resource providers based at least in part on the respective program data;
generating, based at least in part on the at least one impact value of the plurality of resource providers, a predictive output comprising:
a ranking of the plurality of resource providers; and
an indication of a program for obtaining the at least one resource, wherein the program is based at least in part on a top-ranked entry of the ranking and comprises the at least one impact value associated with the top-ranked entry of the ranking;
generating a resource cost electronic record based at least in part on the predictive output and the at least one impact value associated with the top-ranked entry of the ranking; and
causing performance of at least one project responsive action based at least in part on the resource cost electronic record.
